(19) United States
(12) Patent Application Publication
(10) Pub. No.: US 2012/0287931 A1
(43) Pub. Date: Nov. 15, 2012

(54) TECHNIQUES FOR SECURING A VIRTUALIZED COMPUTING ENVIRONMENT USING A PHYSICAL NETWORK SWITCH

(75) Inventors: Jayakrishna Kidambi, San Jose, CA (US); Nirapada Ghosh, Sunnyvale, CA (US)

(73) Assignee: INTERNATIONAL BUSINESS MACHINES CORPORATION, ARMONK, NY (US)

(21) Appl. No.: 13/107,397

(22) Filed: May 13, 2011

(51) Int. Cl. H04L 12/56

(52) U.S. Cl. 370/392

(57) ABSTRACT

A technique for securing a virtualized computing environment includes retrieving identification information from a packet received on a physical port of a network switch. Port assignment data (maintained by one of a virtual machine monitor and a virtual machine monitor management station) for a virtual machine identified in the received packet is retrieved. The identification information from the received packet is compared with the port assignment data to determine whether the virtual machine is assigned to the port. In response to determining that the virtual machine is assigned to the port, the packet is forwarded to a destination designated in the packet. In response to determining that the virtual machine is not assigned to the port, the packet is blocked.

### BACKGROUND OF THE INVENTION

1. Technical Field

The present invention relates in general to physical network switches and, in particular, to techniques for securing a virtualized computing environment using a physical network switch.

2. Description of the Related Art

The term ‘utility computing’ has been used to refer to a computational model in which processing, storage and network resources, software, and data are accessible to client computer systems and other client devices (e.g., mobile phones or media players) on demand, much like familiar residential utility services, such as water and electricity. In some implementations, the specific computational resources (e.g., servers, storage drives, etc.) allocated for access and use by client devices are specified by service agreements between the utility computing provider and its customers. In other implementations, commonly referred to as “cloud computing,” details of the underlying information technology (IT) infrastructure are transparent to the utility computing customers.

Cloud computing is facilitated by ease-of-access to remote computing websites (e.g., via the Internet or a private corporate network) and frequently takes the form of web-based resources, tools or applications that a cloud consumer can access and use through a web browser, as if the resources, tools or applications were a local program installed on a computer system of the cloud consumer. Commercial cloud implementations are generally expected to meet quality of service (QoS) requirements of cloud consumers, which may be specified in service level agreements (SLAs). In a typical cloud implementation, cloud consumers consume computational resources as a service and pay only for the resources used.

Adoption of utility computing has been facilitated by the widespread utilization of virtualization, which is the creation of virtual (rather than actual) versions of computing resources, e.g., an operating system, a server, a storage device, network resources, etc. For example, a virtual machine (VM), also referred to as a logical partition (LPAR), is a software implementation of a physical machine (e.g., a computer system) that executes instructions like a physical machine. VMs can be categorized as system VMs or process VMs. A system VM provides a complete system platform that supports the execution of a complete operating system (OS), such as Windows, Linux, AIX, Android, etc., as well as its associated applications. A process VM, on the other hand, is usually designed to run a single program and support a single process. In either case, any application software running on the VM is limited to the resources and abstractions provided by that VM. Consequently, the actual resources provided by a common IT infrastructure can be efficiently managed and utilized through the deployment of multiple VMs, possibly associated with multiple different utility computing customers.

The virtualization of actual IT resources and management of VMs is typically provided by software referred to as a VM monitor (VMM) or hypervisor. In various implementations, a VMM may run on bare hardware (Type 1 or native VMM) or on top of an operating system (Type 2 or hosted VMM).

In a typical virtualized computing environment, VMs can communicate with each other and with physical entities in the IT infrastructure of the utility computing environment utilizing conventional networking protocols. As is known in the art, conventional networking protocols are commonly premised on the well known seven layer Open Systems Interconnection (OSI) model, which includes (in ascending order) physical, data link, network, transport, session, presentation, and application layers. VMs are enabled to communicate with other network entities as if the VMs were physical network elements through the substitution of a virtual network connection for the conventional physical layer connection.

Software deployed on a known physical network switch has been configured to identify VMs based on medium access control (MAC) addresses associated with the VMs. The software has allowed a user to create a VM group, add VMs to the group, and specify VMs via a variety of identifiers (e.g., Internet protocol (IP) address, universal unique identifier (UUID), and name).

### SUMMARY OF THE INVENTION

A technique for securing a virtualized computing environment includes retrieving identification information from a packet received on a physical port of a network switch. Port assignment data (maintained by one of a virtual machine monitor and a virtual machine monitor management station) for a virtual machine identified in the received packet is also retrieved. The identification information from the received packet is compared with the port assignment data to determine whether the virtual machine is assigned to the port. In response to determining that the virtual machine is assigned to the port, the packet is forwarded to a destination designated in the packet. In response to determining that the virtual machine is not assigned to the port, the packet is blocked.

### BRIEF DESCRIPTION OF THE DRAWINGS

FIG. 1 is a high level block diagram of a data processing environment in accordance with one embodiment;

FIG. 2 depicts the layering of virtual and physical resources in the exemplary data processing environment of FIG. 1 in accordance with one embodiment;

FIG. 3 is a high level block diagram of a data processing system in accordance with one embodiment;

FIG. 4 is a high level block diagram of a relevant portion of a data processing environment that implements network security at a physical network switch in accordance with one embodiment;

FIG. 5 is a high level block diagram of a relevant portion of a physical network switch configured in accordance with one embodiment; and

FIG. 6 is a high level logical flowchart of an exemplary method of securing a data processing environment using a physical network switch in accordance with one embodiment.

### DETAILED DESCRIPTION OF ILLUSTRATIVE EMBODIMENT

As noted above, software of a known physical network switch has stored a medium access control (MAC) address as a virtual machine (VM) identifier in configuration and data structures of the physical network switch to facilitate securing an associated virtualized computing environment. Unfortunately, dependence on MAC addresses as VM identifiers have certain limitations. For example, using MAC addresses as VM identifiers may allow a user of an end station (i.e., a physical machine) that has root privileges to spoof a source MAC address and gain undue access to a virtual local area network (VLAN). Another limitation of using MAC addresses as VM identifiers is that a MAC address may be assigned to another VM or end station, in addition to an original VM. Yet another limitation of using MAC addresses as VM identifiers is that an original VM may be destroyed, and a MAC address of the original VM may be redistributed to a new VM. In general, MAC addresses may get intentionally duplicated (e.g., simultaneous use of a MAC address in a multi-tenant scenario) or unintentionally duplicated (e.g., via a software bug) and, thus, not uniquely or correctly identify a VM.

According to various aspects of the present disclosure, different validation modes may be employed depending on the likelihood of a MAC address being duplicated or reassigned. For example, a first validation mode may be implemented that performs a basic check to guard against MAC address spoofing. As another example, a second validation mode may be implemented to perform a more elaborate check that addresses spoofing, duplication, and reassignment of MAC addresses. In general, the first validation mode is simpler and potentially faster than the second validation mode and can be deployed in environments where it is known that MAC address reassignment and duplication cannot occur. While the discussion herein is primarily directed to techniques that are specific to VMware™, it should be appreciated that the techniques may be extended to other virtualization vendor platforms that provide secure application programming interfaces (APIs) to facilitate access to VM port assignment data maintained by a virtual machine monitor (VMM) and/or a VMM management station.

Each of the first and second validation modes employ periodic discovery messages that advertise a switch identifier (e.g., Internet protocol (IP) address) and switch port number (for a physical network switch) to a server port. In general, discovery messages cannot be generated by arbitrary systems on a network as, by standard, discovery messages cannot be forwarded by a physical network switch from one port to another port. As such, a discovery message received by a VMM is guaranteed to have originated from a directly connected physical network switch. In various embodiments, a physical network switch periodically transmits a discovery message on each server port (e.g., internal ports on bladed switches and specially marked server ports on top-of-rack (ToR) switches). For example, a physical network switch may transmit discovery messages that are compliant with a Cisco discovery protocol (CDP) or a link layer discovery protocol (LLDP).

As is known, VMware™ ESX™ server software may be configured to ‘listen’ for discovery messages on all physical network interface cards (NICs) and collect and store discovery message data for each physical NIC. It should be appreciated that the stored discovery message data can be retrieved (e.g., using a VMware™ virtual infrastructure (VI) API) by a physical network switch or other device. According to various aspects of the present disclosure, the combination of discovery message advertisements on server ports and retrieval of selected port assignment data (by a physical network switch) using a secure API readily facilitates reliable identification of ports being used by VMM servers (per the first validation mode) and cross-checking a VM MAC address (and other information) to physical network switch port mapping (per the second validation mode), as maintained by a physical network switch.

In the first validation mode, configuration of physical network switch software is allowed only on VMM (e.g., ESX™) ports. By disallowing spoofing at the VMM (i.e., VMs are allowed to use only MAC addresses assigned to them by the VMM), VMM ports can be safely assumed to be spoof-proof. In the first validation mode, VMM ports can be identified by transmitting discovery messages from a physical network switch on server ports and using a secure API (e.g., the VI API) to scan through the discovery message data stored against each physical NIC in an inventory hierarchy (e.g., the VMware™ vCenter™ inventory hierarchy). A given physical network switch port is deemed to be a VMM port if the switch port can be located in the scan. That is, when some physical port in the VMM inventory has a same switch identifier and switch port identifier as a switch port in question, the switch port is deemed to be a VMM port.

It should be appreciated that VMM port marking/validation may require invocation in a number of different scenarios in which a physical network switch port has not yet been marked as a VMM port. For example, when a VM interface is added to a VM group and a MAC address of the VM is already in a level 2 (L2) table of a physical network switch, i.e., the MAC address is already ‘active’ on a switch port, VMM port marking/validation requires invocation. As another example, when a VM interface is already in a VM group of a physical network switch and a MAC address of the VM interface experiences a ‘source miss’ on a port of the network switch (commonly referred to as pre-provisioning), VMM port marking/validation requires invocation.

Another scenario to consider is a link-up event on a port. If a port that is marked as a VMM port goes down, a VMM port attribute for the port should be cleared in the event that the port is subsequently connected to an end station that is not managed by the VMM. In this case, when the link comes back up, VMM port validation should be initiated. Link validation may be performed according to the ‘source miss’ scenario or by proactively checking if the VMM port association remains intact before VMs begin transmitting traffic on the VMM port. Validation for the ‘source miss’ scenario may be performed ‘in-band’, since the ‘source miss’ is triggered by the first arriving packet from the VM.

Functionality may be affected if, during validation, subsequent packets from a VM are discarded. However, since the first packets arriving from a VM at a physical network switch port are typically proxied by the VMM (e.g., ESX™ sends a reverse address resolution protocol (RARP) packet with a MAC address of a VM as a source address) and real packets from the VM arrive much later in time, in most situations validation completes (success or failure) ahead of the first non-proxied packets from the VM. In general, a time between the first proxied packet and the first real packet from the VM is typically longer during VM startup than during live VM migration (e.g., VMware™ VMotion™). In the event that real packets from the VM get dropped during validation, the discards are not expected to affect functionality with most upper level protocols (e.g., transfer control protocol (TCP)). While a slight performance degradation may occur due to dropped packets, discards are not unexpected during live migration.

In the second validation mode, software configuration at a physical network switch for a given VM interface is usually applied only after verifying the connectivity of the given VM interface. In the second validation mode, the VM MAC address is stored along with the universal unique identifier (UUID) of the VM to ensure unambiguous identification of the VM interface. When a physical network switch starts receiving packets from a VM that is in a VM group of the network switch, the switch checks to determine if the VM interface specified by the user (i.e., in the configuration of the switch) is the VM interface that is transmitting on the switch port where the packets are being received. The second validation mode uses similar techniques as described in conjunction with the first validation mode. That is, discovery messages are used along with secure API port assignment data retrieval (e.g., from a VMware™ Virtual Center™ inventory). One difference between the first and second validation modes lies in the granularity of checking. Instead of just checking if some physical interface in the VMware™ Virtual Center™ inventory is connected to the switch port as in the first validation mode, the second validation mode (in one or more embodiments) checks four parameters (i.e., VM MAC address, VM UUID, switch port, and switch ID) between the network switch and the VMM inventory for consistency.

At the network switch, the MAC address and UUID of the VM, as well as the switch ID, are stored in a current configuration file, while the port number comes from the L2 table of the switch when the VM is active. The VI API client (i.e., the physical network switch) locates the VM interface in the VMware™ Virtual Center™ inventory based on the UUID and MAC address of the VM. The VI API client then reads the port assignment data of the corresponding physical NIC (by mapping a port group of the VM interface to its virtual switch, then to the physical NIC/NICs that act as uplinks for the virtual switch). The port assignment data provides the switch ID and port number, based on received discovery message data. In one or more embodiments, the MAC address appearing on the switch port is deemed verified only if the four parameters match exactly. This check guards against spoofing MAC addresses, duplicate MAC addresses, and reused MAC addresses.

In one or more embodiments, software executing on a physical network switch invokes a send routine periodically (e.g., every minute) to transmit a discovery message. The send routine transitions through a list of configured ports to determine which ports require transmission of advertisements with discovery message data. It should be noted that all internal ports and server ports are by default configured to send out advertisements and when some ports are removed, the removed ports do not get saved in the configuration and, as such, do not survive ‘reset’. As used herein, the term ‘internal ports’ refer to embedded physical network switches (which reside inside a blade server and have fixed server and non-server ports) and the term ‘server ports’ refer to non-embedded physical network switches (which have ports that can connect to server and other physical network switches and, as such, require explicit designation of server ports). In one or more embodiments, when a link comes up on a port which is configured to send out discovery messages, a discovery message is immediately transmitted. In various embodiments, UUIDs of configured VMs are saved in a configuration file to facilitate strict checking. A global array may be maintained at the network switch to hold port settings. In one or more embodiments, two copies of the global array (i.e., a first copy to hold settings when the configuration is not applied and a second copy that corresponds to a current configuration) are maintained. In various embodiments, each VM belonging to a VM group is tracked to determine when a MAC address of the VM requires verification.

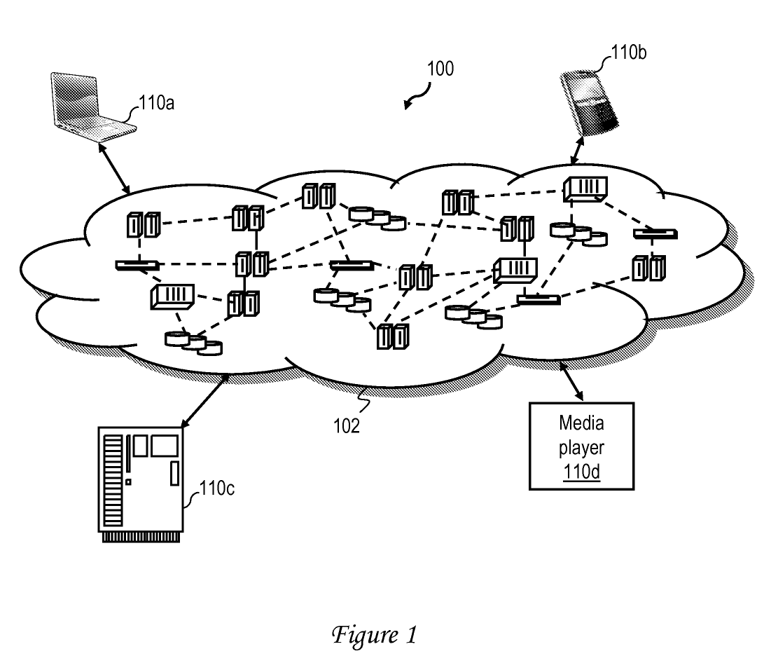

With reference now to the figures and with particular reference to FIG. 1, there is illustrated a high level block diagram of an exemplary data processing environment 100 in accordance within one embodiment of the present disclosure. As shown, data processing environment 100, which in the depicted embodiment is a cloud computing environment, includes a collection of computing resources commonly referred to as a cloud 102. Computing resources within cloud 102 are interconnected for communication and may be grouped (not shown) physically or virtually, in one or more networks, such as private, community, public, or hybrid clouds or a combination thereof. In this manner, data processing environment 100 can offer infrastructure, platforms and/or software as services accessible to client devices 110, such as personal (e.g., desktop, laptop, netbook, tablet or handheld) computers 110a, smart phones 110b, server computer systems 110c and consumer electronics 110d, such as media players (e.g., set top boxes, digital versatile disk (DVD) players, or digital video recorders (DVRs)). It should be understood that the types of client devices 110 shown in FIG. 1 are illustrative only and that client devices 110 can be any type of electronic device capable of communicating with and accessing services of computing resources via a packet network.

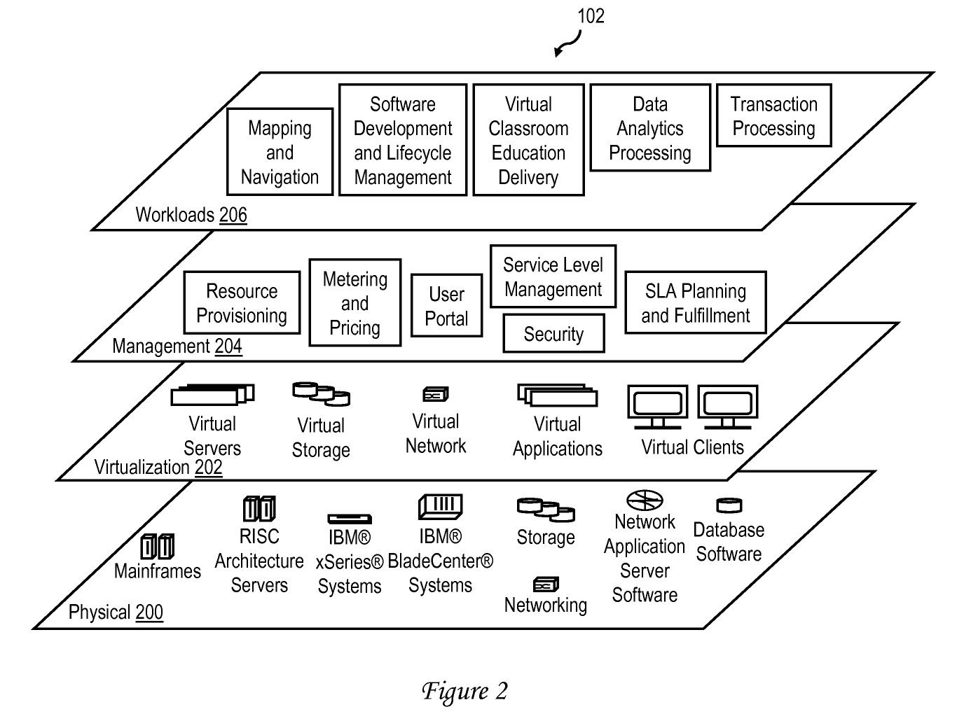

FIG. 2 is a layer diagram depicting the virtual and physical resources residing in cloud 102 of FIG. 1 in accordance with one embodiment. It should be understood that the computing resources, layers, and functions shown in FIG. 2 are intended to be illustrative only and embodiments of the claimed inventions are not limited thereto.

As depicted, cloud 102 includes a physical layer 200, a virtualization layer 202, a management layer 204, and a workloads layer 206. Physical layer 200 includes various physical hardware and software components that can be used to instantiate virtual entities for use by the cloud service provider and its customers. As an example, the hardware components may include mainframes (e.g., IBM® zSeries® systems), reduced instruction set computer (RISC) architecture servers (e.g., IBM pSeries® systems), IBM xSeries® systems, IBM BladeCenter® systems, storage devices (e.g., flash drives, magnetic drives, optical drives, tape drives, etc.), physical networks, and networking components (e.g., routers, switches, etc.). The software components may include operating system software (e.g., AIX, Windows, Linux, etc.), network application server software (e.g., IBM WebSphere® application server software, which includes web server software), and database software (e.g., IBM DB2®, database software). IBM, zSeries, pSeries, xSeries, BladeCenter, WebSphere, and DB2 are trademarks of International Business Machines Corporation registered in many jurisdictions worldwide.

The computing resources residing in physical layer 200 of cloud 102 are virtualized and managed by one or more virtual machine monitors (VMMs) or hypervisors. The VMMs present a virtualization layer 202 including virtual entities (e.g., virtual servers, virtual storage, virtual networks (including virtual private networks)), virtual applications, and virtual clients. As discussed previously, these virtual entities, which are abstractions of the underlying resources in physical layer 200, may be accessed by client devices 110 of cloud consumers on-demand.

The VMM(s) also support a management layer 204 that implements various management functions for the cloud 102. These management functions can be directly implemented by the VMM(s) and/or one or more management or service VMs running on the VMM(s) and may provide functions such as resource provisioning, metering and pricing, security, user portal services, service level management, and SLA planning and fulfillment. The resource provisioning function provides dynamic procurement of computing resources and other resources that are utilized to perform tasks within the cloud computing environment. The metering and pricing function provides cost tracking (as resources are provisioned and utilized within the cloud computing environment) and billing or invoicing for consumption of the utilized resources. As one example, the utilized resources may include application software licenses. The security function provides identity verification for cloud consumers and tasks, as well as protection for data and other resources. The user portal function provides access to the cloud computing environment for consumers and system administrators. The service level management function provides cloud computing resource allocation and management such that required service levels are met. For example, the security function or service level management function may be configured to limit deployment/migration of a virtual machine (VM) image to geographical location indicated to be acceptable to a cloud consumer. The SLA planning and fulfillment function provides pre-arrangement for, and procurement of, cloud computing resources for which a future requirement is anticipated in accordance with an SLA.

Workloads layer 206, which may be implemented by one or more consumer VMs, provides examples of functionality for which the cloud computing environment may be utilized. Examples of workloads and functions which may be provided from workloads layer 206 include: mapping and navigation; software development and lifecycle management; virtual classroom education delivery; data analytics processing; and transaction processing.

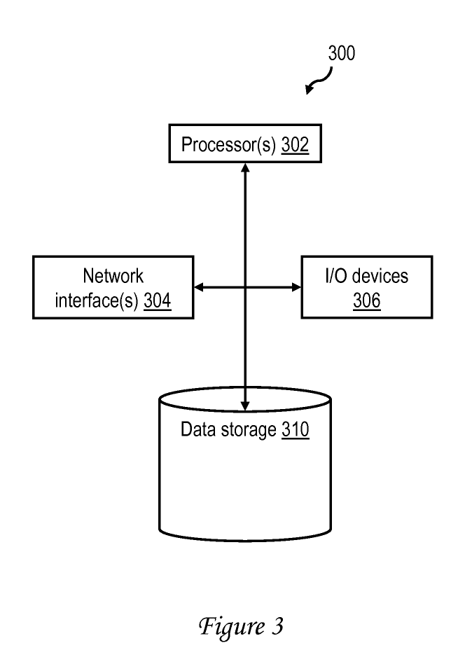

With reference now to FIG. 3, there is illustrated a high level block diagram of an exemplary data processing system 300 that can be utilized to implement a physical host computing platform in physical layer 200 of FIG. 2 or a client device 110 of FIG. 1. In the illustrated exemplary embodiment, data processing system 300 includes one or more network interfaces 304 that permit data processing system 300 to communicate with one or more computing resources in cloud 102 via cabling and/or one or more wired or wireless, public or private, local or wide area networks (including the Internet). Data processing system 300 additionally includes one or more processors 302 that process data and program code, for example, to manage, access and manipulate data or software in data processing environment 100. Data processing system 300 also includes input/output (I/O) devices 306, such as ports, displays, and attached devices, etc., which receive inputs and provide outputs of the processing performed by data processing system 300 and/or other resource(s) in data processing environment 100. Finally, data processing system 300 includes data storage 310, which may include one or more volatile and/or non-volatile storage devices, including memories, solid state drives, optical or magnetic disk drives, tape drives, etc. Data storage 310 may store, for example, software within physical layer 200 and/or software, such as a web browser, that facilitates access to workloads layer 206 and/or management layer 204.

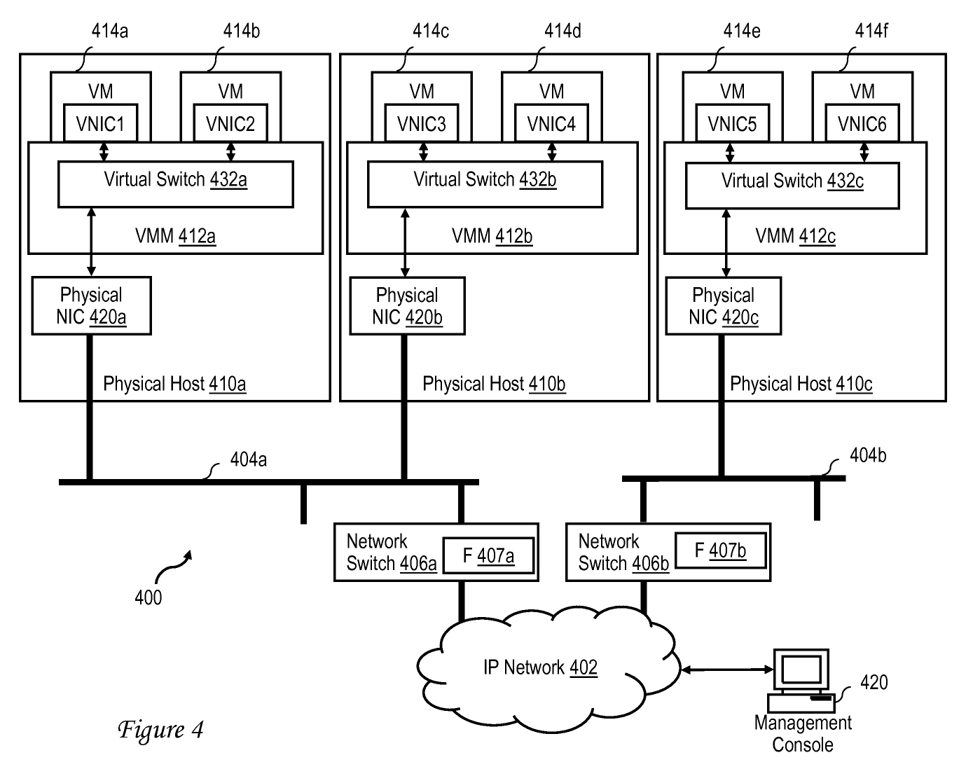

Referring now to FIG. 4, there is depicted a high level block diagram of a relevant portion of a data processing environment 400 employing virtual networking in accordance with one embodiment of the present disclosure. For example, data processing environment 400 can implement a portion of cloud 102 depicted in FIG. 1.

In the depicted embodiment, data processing environment 400 includes an Internet protocol (IP) network 402 including a plurality of network segments 404a, 404b, each of which is coupled to a respective one of physical network switches 406a, 406b. As is depicted, each of physical network switches 406a, 406b includes a respective data structure (e.g., a respective forwarding table (F)) 407a, 407b by which physical network switches 406a, 406b forward incoming data packets toward the packets' destinations based upon, for example, OSI Layer 2 (e.g., MAC) addresses contained in the packets. Physical hosts 410a, 410b are coupled to network segment 404a and physical host 410c is coupled to network segment 404b. Each of physical hosts 410a-410c can be implemented, for example, utilizing a data processing system 300 as depicted in FIG. 3.

Each of physical hosts 410a-410c executes a respective one of VMM 412a-412c, which virtualizes and manages the resources of its respective physical host 410, for example, under the direction of a human and/or automated cloud administrator at a VMM management console 420 (which can be implemented using data processing system 300 as depicted in FIG. 3) coupled to physical hosts 410a-410c by IP network 402. VMM 412a on physical host 410a supports the execution of VMs 414a, 414b, VMM 412b on physical host 410b supports the execution of VMs 414c, 414d, and VMM 412c on physical host 410c supports the execution of VMs 414e, 414f. As one example, management console 420 may be configured to execute VMware™ vCenter Server™ to manage VMMs 412a-412c. It should be appreciated that while two VMs are illustrated as being deployed on each of physical hosts 410a-410c, more or less than two VMs may be deployed on a physical host configured according to the present disclosure. In various embodiments, VMs 414a-414f can include VMs of one or more cloud consumers and/or a cloud provider. In the depicted embodiment, each of VMs 414 has one (and may include multiple) virtual network interface controller VNIC1-VNIC6, which provide network connectivity at least at Layers 2 and 3 of the OSI model.

Virtual switch 432a is configured to forward at least some communications from/to VNIC1 and VNIC2 of VMs 414a, 414b, respectively, to physical network switch 406a (over network segment 404a) using physical NIC 420a. Virtual switch 432b is configured to forward at least some communications from/to VNIC3 and VNIC4 of VMs 414c, 414d, respectively, to physical network switch 406a (over network segment 404a) using physical NIC 420b. Similarly, virtual switch 432c is configured to forward at least some communications from/to VNIC5 and VNIC6 of VMs 414e, 414f, respectively, to physical network switch 406b (over network segment 404b) using physical NIC 420c. In various embodiments, physical switches 406a, 406b are configured to communicate (e.g., via a secure API) with management console 420 to retrieve port assignment data to validate port assignments for VMs 414a-414f. In one or more embodiments, management console 420 may maintain the port assignment data for VMs 414a-414f or may facilitate access to port assignment data for VMs 414a-414f, respectively, that is maintained by VMMs 412a-412c.

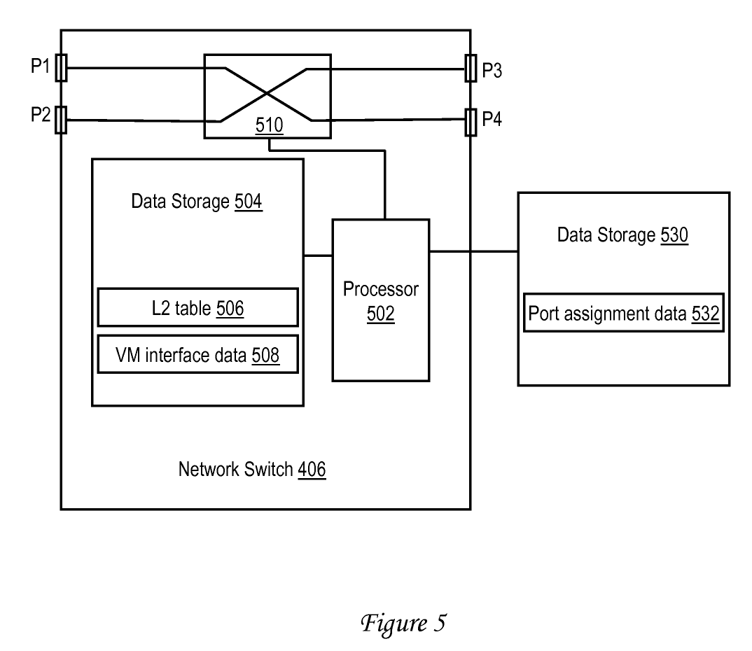

Referring now to FIG. 5, a relevant portion of physical network switch 406 in data processing environment 400 of FIG. 4 is depicted in accordance with one embodiment of the present disclosure. As is illustrated, physical network switch 406 includes four ports (labeled P1-P4), a crossbar switch 510, a processor 502, and a data storage (e.g., a memory subsystem) 504. While the network switch 406 is shown with four ports, it should be appreciated that a network switch configured according to the present disclosure may include more or less than four ports. Processor 502, which is coupled to crossbar switch 510, controls crossbar switch 510 to route traffic between ports P1-P4. Data storage 504 maintains L2 table 506 and VM interface data 508. As noted above, MAC addresses and UUIDs of active VMs 414 and a switch ID of physical network switch 406 are stored in a VM interface data file 508 (i.e., a current configuration file), while port numbers for active VMs 414 are provided by L2 table 506. Physical network switch 406 (which is also a secure API client) locates a VM interface in a port assignment data inventory 532 (of data storage 530) based on a UUID and a MAC address of a VM. Data storage 530 may be maintained by VMM 412 on physical host 410 and/or by VMM management console 420. For example, data storage 530 may correspond to a hard disk drive (HDD).

Physical network switch 406 reads port assignment data (from port assignment data inventory 532 via a secure API) of a corresponding physical NIC 420 (by mapping a port group of the VM interface to an associated virtual switch 432, then to a physical NIC 420 that acts as an uplink for virtual switch 432). The port assignment data provides the switch ID and port number, based on received discovery message data. In one or more embodiments, a MAC address appearing on a switch port of physical network switch 406 is deemed verified only if all four parameters (i.e., VM MAC address, VM UUID, switch port, and switch ID) match exactly. As noted above, verifying that all four parameters match exactly advantageously guards against spoofing MAC addresses, duplicate MAC addresses, and reused MAC addresses.

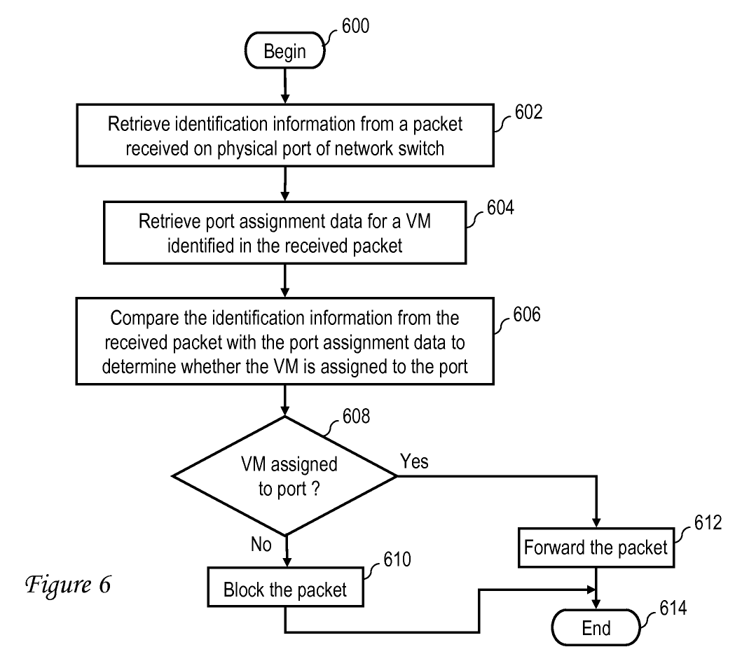

With reference now to FIG. 6, there is illustrated a high level logical flowchart of an exemplary method of securing a virtualized computing environment in accordance with one embodiment of the present disclosure. The flowchart of FIG. 6 depicts steps in logical rather than strictly chronological order. Thus, in at least some embodiments, at least some steps of a logical flowchart can be performed in a different order than illustrated or concurrently. The process illustrated in FIG. 6 can be performed by each physical network switch 406 in data processing environment 400 of FIG. 4. For example, each physical network switch 406 may be implemented by a data processing system 300 of FIG. 3.

The process, which implements the second validation mode and is configured to secure data processing environment 400 at physical network switch 406, begins at block 600 and then proceeds to block 602, where physical network switch 406 retrieves identification information from a packet received from one of VMs 414 on a physical port of network switch 406. For example, the identification information may include a VM MAC address and a VM UUID for VM 414a. Next, in block 604, physical network switch 406 retrieves port assignment data maintained by VMM 412 (and/or management console 420) for the VM (e.g., VM 414a) identified in the received packet. For example, the port assignment data may include a VM MAC address, a VM UUID, a switch port, and a switch ID retrieved from a VMware™ inventory (accessed via a VI API) for VMs 414. As discussed above, the switch port, and the switch ID are periodically provided from physical network switch 406 to VMM 412 in a discovery message. Then, in block 606, physical network switch 406 compares the identification information from the received packet (as well as the switch port and the switch ID maintained by physical network switch 406) with the port assignment data maintained by VMM 412 (and/or management console 420) to determine whether the VM 414 indicated by the identification information of the received packet is assigned to the switch port.

In decision block 608, control transfers to block 612 in response to physical network switch 406 determining that the VM 414 indicated by the identification information of the received packet is assigned to the switch port on which the packet was received. In block 612, physical network switch 406 forwards the packet to a destination designated in the packet. In block 608, control transfers to block 610 in response to physical network switch 406 determining that the VM 414 indicated by the identification information of the received packet is not assigned to the port that the packet was received on. In block 610, physical network switch 406 blocks the packet (e.g., discards the packet or forwards the packet to a network security routine for reporting purposes). Following blocks 610 and 612, the process depicted in FIG. 6 ends at block 614.

While the present invention has been particularly shown as described with reference to one or more preferred embodiments, it will be understood by those skilled in the art that various changes in form and detail may be made therein without departing from the spirit and scope of the invention. For example, it should be understood that although the detailed description provided herein provides multiple embodiments of cloud computing environments, the teachings disclosed herein are not limited to cloud computing environments. Rather, embodiments can be implemented in any other type of computing environment now known or later developed, including client-server and peer-to-peer computing environments.

Further, although aspects have been described with respect to computer systems executing program code that direct the functions described herein, it should be understood that embodiments may alternatively be implemented as a program product including a storage medium (e.g., data storage 310) storing program code that can be processed by a data processing system to cause the data processing system to perform one or more of the described functions.

1-7. (canceled)

8. A network switch, comprising:
data storage storing program code; and
a processor coupled to the data storage, wherein the program code, when executed by the processor, configures the processor for:
retrieving identification information from a packet received on a physical port of a network switch;
retrieving port assignment data, maintained by one of a virtual machine monitor and a virtual machine monitor management station, for a virtual machine identified in the received packet;
comparing the identification information from the received packet with the port assignment data to determine whether the virtual machine is assigned to the port;
in response to determining that the virtual machine is assigned to the port, forwarding the packet to a destination designated in the packet; and
in response to determining that the virtual machine is not assigned to the port, blocking the packet.

9. The network switch of claim 8, wherein the program code further configures the processor for:
advertising the port to the virtual machine monitor using a discovery message.

10. The network switch of claim 9, wherein the discovery message employs a link layer discovery protocol.

11. The network switch of claim 9, wherein the discovery message includes a switch port number for the port of the network switch and a switch identifier for the network switch.

12. The network switch of claim 8, wherein the port assignment data includes a medium access control address for the virtual machine, a universal unique identifier for the virtual machine, an assigned switch port number for the virtual machine, and an assigned switch identifier for the virtual machine.

13. The network switch of claim 8, wherein the identification information for the received packet includes a medium access control address for the virtual machine and a universal unique identifier for the virtual machine, and wherein the network switch maintains a switch port number for the port of the network switch and a switch identifier for the network switch.

14. The network switch of claim 8, wherein the identification information for the received packet includes a medium access control address for the virtual machine and a universal unique identifier for the virtual machine.

15. A program product for securing a virtualized computing environment, the program product including program code embodied in data storage, the program code when executed by a processor configures the processor for:
retrieving identification information from a packet received on a physical port of a network switch;
retrieving port assignment data, maintained by one of a virtual machine monitor and a virtual machine monitor management station, for a virtual machine identified in the received packet;
comparing the identification information from the received packet with the port assignment data to determine whether the virtual machine is assigned to the port;
in response to determining that the virtual machine is assigned to the port, forwarding the packet to a destination designated in the packet; and
in response to determining that the virtual machine is not assigned to the port, blocking the packet.

16. The program product of claim 15, wherein the program code when executed by the processor further configures the processor for:
advertising the port to the virtual machine monitor using a discovery message.

17. The program product of claim 16, wherein the discovery message employs a link layer discovery protocol.

18. The program product of claim 16, wherein the discovery message includes a switch port number for the port of the network switch and a switch identifier for the network switch.

19. The program product of claim 15, wherein the port assignment data includes a medium access control address for the virtual machine, a universal unique identifier for the virtual machine, an assigned switch port number for the virtual machine, and an assigned switch identifier for the virtual machine.

20. The program product of claim 15, wherein the identification information for the received packet includes a medium access control address for the virtual machine and a universal unique identifier for the virtual machine, and wherein the network switch maintains a switch port number for the port of the network switch and a switch identifier for the network switch.
